(19) United States
(12) Patent Application Publication
(10) Pub. No.: US 2015/0170285 A1
(43) Pub. Date: Jun. 18, 2015

(54) UNEXPECTED HOLIDAY MANAGEMENT FOR DEBT INSTRUMENTS

(71) Applicants: Puneet Chhahira, Chandigarh (IN); Abhra Roy, Bangalore (IN); Pradeep Shankar Chinnuswamy, Erode (IN); Shekhar, Gurgaon (IN); Hardik Jayendrabhai Ashra, Rajkot (IN)

(72) Inventors: Puneet Chhahira, Chandigarh (IN); Abhra Roy, Bangalore (IN); Pradeep Shankar Chinnuswamy, Erode (IN); Shekhar, Gurgaon (IN); Hardik Jayendrabhai Ashra, Rajkot (IN)

(73) Assignee: INFOSYS LIMITED, Bangalore (IN)

(21) Appl. No.: 14/385,738

(22) PCT Filed: Mar. 23, 2012
(86) PCT No.: PCT/IN2012/000194

§ 371 Date: Mar. 3, 2015

(51) Int. Cl. G06Q 40/06; G06Q 10/10

(52) U.S. Cl. CPC G06Q 40/06; G06Q 10/1097

(57) ABSTRACT

Post creation of debt products, if holidays are announced and calendars are accordingly modified, a manual update is done across all the products if any of current dates falls on the new holiday dates. Thus, while it might be relatively easy during a creation of debt instrument to verify that the proposed or the actual dates scheduled on the calendar is not concurrent with the holiday data set, it can be both, difficult and time-consuming to ensure that an unexpected holiday is accounted for and adapted in the associated calendar. Accordingly, systems and methods are disclosed for automatically managing the impacted dates of debt products upon the occurrence of unexpected holiday(s).

### FIELD OF THE INVENTION

The present disclosure relates, in general, to the field of financial instruments and, in particular, to methods and systems for improving the efficiency of communicating information pertaining to debt instruments.

### BACKGROUND OF THE INVENTION

Electronic information processing and communication systems are playing an increasingly important role in coordinating business operations among various participants in a financial community. Banks are significant investors in local currency debt in developing economies and one of the significant participants in domestic bond markets. Debt instruments are complex investment products, the performance of which depends on several basic characteristics. It is a long-term commitment to debt holders since the issuers have to meet the obligations for as long as the bond is outstanding. A bond is a type of debt instrument which is a contract to pay interest and repay principal. It is both, a financial instrument and a legal obligation, enforceable in court. Information relating to a bond that will be issued can include, for example, the bond's issue date, payment periods, its maturity, redemption features, coupons, type of coupon involved, the bond's yield calculation method, amortization, or other information descriptive of the bonds to be issued. The ongoing responsibly of managing debt instrument, for example, bonds, falls on the issuer as regards the debt payments and to ensure the timely delivery of such payments. The bond offering will require the issuer to ensure compliance with the bond terms as per the executed documents. The issuers of debt instruments and the debt holders will depend on the legally enforceable document and the corresponding applicable interest rates to calculate amounts such as interest amount, principal amounts, among other things. The conditions might depend on such factors as the calendar day, that is, on whether it is a workday, weekend day or public holiday. This can affect the way interest is calculated on a given calendar day.

In general, while scheduling the dates pertaining to a bond, the calendar is checked against a holiday data set, specific for a particular region, territory or country of the world. These [symbol] data sets may also be inclusive of the unofficial holidays pertaining to a particular region, territory or country (for example, the week between Christmas and January 1^{st}) which can impact the completion of the business transaction or action to be completed on that particular that. This is primarily due to the reason that a large number of businesses may remain closed and due to employee vacations occurring on this date. Therefore, when the financial institutions or the companies schedule dates pertaining to debt instruments, for example, bonds, it is important for them to consider the national, state, bank and corporate holidays in countries that use the currencies involved in the transactions. Most countries have their own set of holidays, of which only a few are observed in other countries around the world. For example, in India, a business action date may not be scheduled for August 15^{th} and this may not apply to other countries across the world. In United States, typically, banks will be closed for July 4^{th}. One of ordinary skill will appreciate that a holiday is not limited to national holidays or holidays declared by a corporate. Generalizing, a holiday should be broadly construed to cover any given type of event that may be designated by an administrator or a third party, to have local significance (even though the event may not have significance in some other locale in which the managed region is supported). For example, a specific locale may designate certain days of the calendar for carrying out the operations. When debt instruments are created using software, such as a wealth management system, for example, the cash flows generated based on the currency calendars may be mapped to the product. As used herein, the terms ‘currency calendar’, ‘currency holiday calendar’, currency settlement holidays' are used somewhat interchangeably. In order for a date to be a valid settlement date, the banks for that currency must be open for settlements. If either currency has a holiday on the target settlement date, settlement is deferred until the next valid business day for both currencies. However these currency calendars may not have holidays maintained for [symbol] uration of the debt instrument as the holiday calendars for different currencies may not available beyond two to three years. When a bank creates financial products using these calendars, the holidays for future years are not taken into account. Issuers maintain various future dates where business actions are proposed to happen. In addition to this, the dates maintained need to be valid business days. The term ‘business day’, as used herein, means any day on which the financial institutions are open for business.

It is seen that post creation of debt products, when the holidays are announced and calendars are modified; a manual update is done across all the products, if any of current dates falls on the new holiday dates. When holidays are added to the calendar, there is a need for a provision to change all the cash flow dates, determination dates, amongst other dates, across all the debt products in the system. This needs to be done with proper checks and controls in place as it involves a debt holder's money. Hence, the data maintained in system needs to be changed as and when holiday data is maintained in system. For example, in the case of bonds, the dates which are primarily impacted based on the holiday data set include adjusted cash flow dates, adjusted call dates, adjusted put dates, determination date, reference rate dates. The above set of dates needs to be changed based on the changes introduced in the relevant calendars. Changes in calendar can be addition of a new holiday, making a previous marked holiday as working day. This can also be used to track all changes and update the products based on new, unexpected holidays. It will also allow banks to simulate, track and do a mass update across products with proper system checks.

Thus, while it might be relatively easy during a creation of debt instrument to verify that the proposed or the actual dates scheduled on the calendar is not concurrent with the holiday data [symbol] can be both, difficult and time-consuming to ensure that an unexpected holiday is accounted for and adapted in the associated calendar. This is required to be taken care of, as it can impact the scheduling of the business actions and thus there lies a need to adopt an approach which accounts for such variability. There may be a need to manage these ‘unexpected holidays’ and these may need to be accordingly added, modified or deleted from the holiday data set.

Disclosed herein are systems and methods for managing unexpected holidays pertaining to the issued debt instruments.

### SUMMARY OF THE INVENTION

Aspects of the disclosure relate to a system and method for managing unexpected holidays of issued debt products.

It is therefore one object of the present disclosure to provide systems and methods for automatically managing the impacted dates of debt products upon the occurrence of an unexpected holiday.

It is another object of the present disclosure to manage the impacted dates across several debt products as one process.

It is yet another object of the present disclosure to generate reports of the debt products impacted with the occurrence of the unexpected holiday.

The above as well as additional aspects and advantages of the disclosure will become it in the following detailed written description

### BRIEF DESCRIPTION OF THE DRAWINGS

The aspects of the disclosure will be better understood with the accompanying drawings.

FIG. 1 is a block diagram of a computing device to which the present disclosure may be applied.

FIG. 2 shows an exemplary architecture of unexpected holiday(s) management system.

FIG. 3 shows an exemplary process with the flow of steps for managing unexpected holiday(s).

FIG. 4 shows an exemplary process with the flow of steps for calculation of determination date and reference rate dates.

While systems and methods are described herein by way of example and embodiments, those skilled in the art recognize that systems and methods disclosed herein are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a [symbol] ve sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide computer-implemented methods, systems, and computer-readable media for managing unexpected holidays of issued debt products. The embodiments described herein are related to bond products; however, such usage is not intended to limit the present disclosure to bond products. To facilitate a clear understanding of the present disclosure, illustrative examples are provided herein which describe certain aspects of the disclosure. However, it is to be appreciated that these illustrations are not meant to limit the scope of the disclosure, and are provided herein to illustrate certain concepts associated with the disclosure.

It is also to be understood that the present disclosure may be implemented in various forms of hardware, software, firmware, special purpose processors, or a combination thereof. Preferably, the present invention is implemented in software as a program tangibly embodied on a program storage device. The program may be uploaded to, and executed by, a machine comprising any suitable architecture.

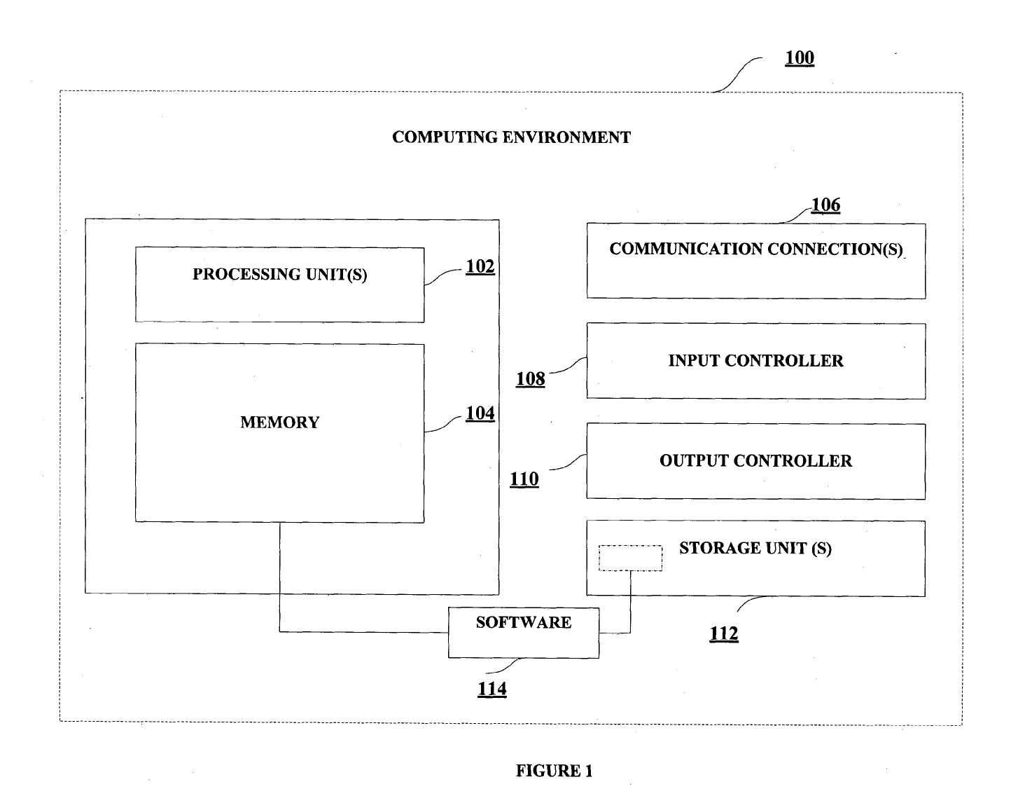

FIG. 1 is a block diagram of a computing device 100 to which the present disclosure may be applied according to an embodiment of the present disclosure. The system includes at least one processor 102, designed to process instructions, for example computer readable [symbol] ions (i.e., code) stored on a storage device 112. By processing instructions, processing device 102 may perform the steps and functions disclosed herein. Storage device 112 may be any type of storage device (e.g., an optical storage device, a magnetic storage device, a solid state storage device, etc.), for example a non-transitory storage device. Alternatively, instructions may be stored in one or more remote storage devices, for example storage devices accessed over a network or the internet. The computing device also includes an operating system and microinstruction code. The various processes and functions described herein may either be part of the microinstruction code or part of the program (or combination thereof) which is executed via the operating system. Computing device 100 additionally may have memory 104, an input controller 108, and an output controller 110. A bus (not shown) may operatively couple components of computing device 100, including processor 102, memory 104, storage device 112, input controller 108, output controller 110, and any other devices (e.g., network controllers, sound controllers, etc.). Output controller 110 may be operatively coupled (e.g., via a wired or wireless connection) to a display device (e.g., a monitor, television, mobile device screen, touch-display, etc.) in such a fashion that output controller 110 can transform the display on display device (e.g., in response to modules executed). Input controller 108 may be operatively coupled (e.g., via a wired or wireless connection) to input device (e.g., mouse, keyboard, touch-pad, scroll-ball, touch-display, etc.) in such a fashion that input can be received from a user. Of course, FIG. 1 illustrates computing device 100 with all components as separate devices for ease of identification only. Each of the components may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a [symbol] of computing devices attached to a single display device and input device, etc.). Computing device 100 may be one or more servers, for example a farm of networked servers, a clustered server environment, or a cloud network of computing devices.

The disclosure herein proposes systems and methods for managing unexpected holidays for debt instruments. The term ‘unexpected holiday’, as used herein, refers to a public holiday, which is not a ‘known public holiday’ and is not maintained in the holiday data set at the time when bonds were issued. The term ‘known public holiday’ refers to any gazette holiday, which is known at the time the bond issued.

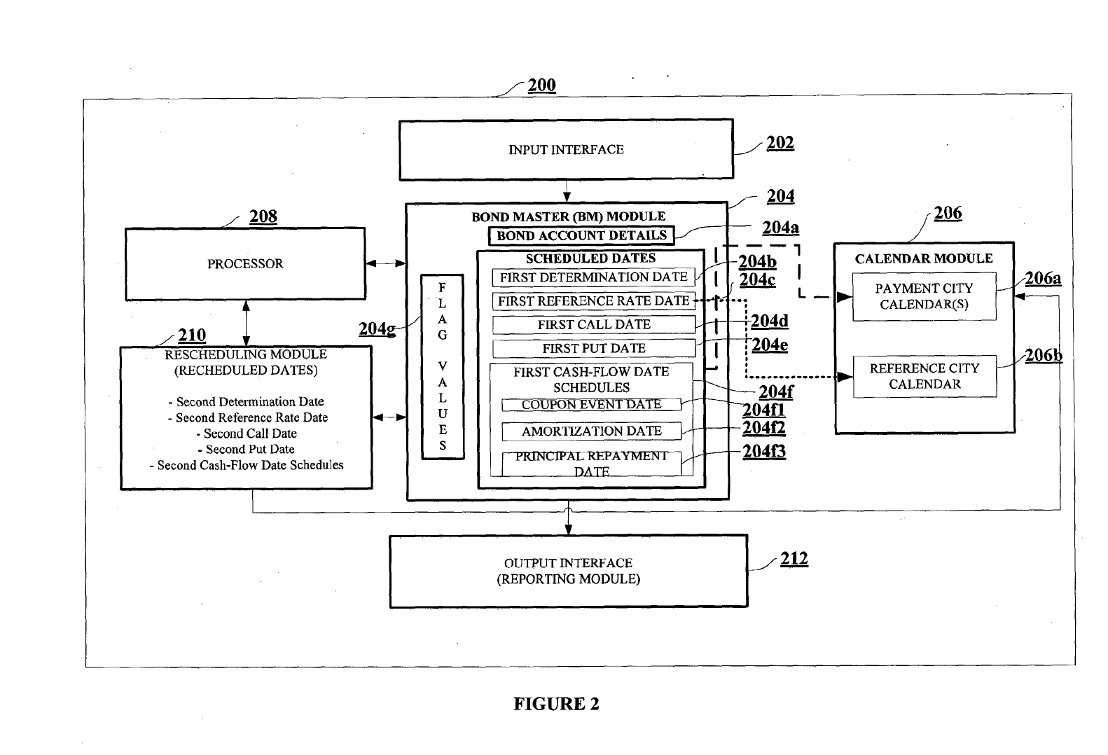

Referring now to FIG. 2, which is an exemplary architecture 200 for managing unexpected holidays for the issued debt instruments. 200 is illustrates a system in which the information processing of the various bond attributes take place. The system can include a computerized server accessible via a distributed network such as the internet. A user can use the computerized system or the network access device to receive data, input data, transmit or view information processed relating to the bonds issued, for example. The user can receive, input, transmit or view information using banking software, for instance, via the input interface 202. The GUI (not depicted in figures) can be presented on the computerized system or a network access device or any other type of terminal capable of creating a display pursuant to an electronic signal. The banking software can have a module, for instance, a ‘bonds master’ (BM) 204 to manage the details of the issued bonds 204a. A portion of the display (not depicted in figures) can display information descriptive of the bond issued, such as for example, the bond's issue date, settlement date, price, yield, from the bonds master (hereinafter may also be referred as ‘BM’). The ‘bonds master’ 204 can maintain the bond code which is the unique code that is [symbol] to a bond being defined in the system. This field can act as the primary key for all the tables where the bond details would be available. The choice of currency in which the bonds will be denominated is market driven and information regarding this can be captured in the ‘bonds master’. The details of the issued bonds can include information which includes payment periods, maturity date, redemption features, coupons, type of coupons involved, the business convention adopted or other information descriptive of the bonds to be issued. Once a bond is offered, an issuer maintains some dates related to the bond and these are scheduled on the system. The issuer needs to maintain these future dates where business actions specific to the issued bonds are scheduled to happen. These future dates correspond to ‘actual dates’ i.e. the dates on which the business transaction pertaining to the bond is scheduled to happen. The actual dates are determined by the system based on the agreed terms in the contract and does not take into account the business day convention. The ‘bonds master’ can maintain the business day convention selected to be applied for the bonds issued in a transaction. It is obvious for one skilled in the art that the selection for business day convention determines how non-business days are treated. The conventions are distinguished by the manner in which they adjust the date from which the interest starts accruing till the settlement date. Each convention has a set of rules directing the adjustments. The type of conventions include Actual/360, Actual/365(fixed), Actual/360 and 30/360, each with a set of rules directing the adjustments If any of these dates fall on a known public holiday, the system reschedules the actual date(s) to an ‘adjusted date’ which will be the next working date as per the currency calendar. This date will be derived from the actual date by checking it for holidays against ‘Payment City Calendars’ and applying business day conventions. If the actual date does not fall on a holiday then the adjusted date remains the same as the actual date. The adjusted dates, unless used otherwise, refer to the following:

Determination Date—The term ‘determination date’ refers to the date on which the interest will be calculated. The term ‘first determination date’ 204b refers to the adjusted determination date by verifying the date against the known public holiday, on the system.

Reference Rate Date—The term ‘reference rate date’ refers to the date when the rate for the underlying coupon base must be considered for coupon rate determination. The term ‘first reference rate date’ 204c refers to the adjusted reference rate date by verifying the date against the known public holiday, on the system.

Call Date—The term ‘call date’ refers to the date when an issuer has the option to redeem all or part of a bond issue before maturity, at a specified price. The term ‘first call date’ 204d refers to the call date adjusted by verifying the actual date against the known public holiday set.

Put Date—The term ‘put date’ refers to the date when a bond can be redeemed at the option of the bond holder for face value plus accrued interest. The term ‘first put date’ 204e refers to the put date adjusted on the system by verifying the actual date against the known public holiday set.

Cash-flow Dates—The term cash-flow dates refers to the date when the cash, which includes the interest and the principal, is repaid in part or whole, to the bond holder. The term ‘first cash-flow date’ 204f refers to the date adjusted on the system by verifying the actual date against the known public holiday set.

Coupon Event Date—The term ‘Coupon Event Date’ 204f1 refers to the date when the bond holder is obliged to pay interest to the bond holder. The coupon event date occurs at periodic intervals based on the type of coupons. Coupons are normally described in terms of the coupon rate, which is calculated by adding the total amount of coupons paid per year and dividing the bond's face value.

Amortization Date—The term ‘Amortization date’ 204f2 refers to the date when part of the principal is repaid, before maturity of the bond.

Principal Repayment Date—Principal refers to the cost of a bond multiplied by the number bonds issued in a transaction. The principal repayment date 204f3 refers to the date when the principal is repaid to the bond holder.

The ‘bonds master’ can also maintain other details of the bond which are necessary for fully defining the bond attributes. For example, the coupon feature of a bond may require that additional attributes be specified for fully defining the bond's coupon feature. These additional attributes may include, by way of non-limiting example, whether the coupons are periodic coupons, detailed coupons or perpetual coupons.

The ‘bonds master’ can communicate with a calendar module 206 for referring to the payment city calendar and the reference city calendar. The adjusted dates are scheduled after checking the actual dates against payment city calendars and applying business day conventions. As used herein, the term payment city calendar corresponds to the country calendar which is to [symbol] red. The ‘bonds master’ can store the details of the one or more currency calendars to be referred. The payment dates i.e. coupon event date 204f1, amortization date 204f2, principal payment date 204f3, first call date 204d and the first put date 204e are scheduled after checking for holidays across the payment city calendars. The first determination date 204b and the maturity date are validated against these payment city calendars. The words ‘electronic calendar’ or ‘calendar’ are used somewhat interchangeably. The reference city calendar 206b indicates the calendar to be referred for checking the market rate of an index, for example, for LIBOR, the London calendar would be observed.

The ‘bonds master’ can also maintain the flag values 204g of the dates related to the issued bond product. The flag values denote the permission to make changes to date entered in the system while creating the bond product. The values can correspond to ‘activated’ and ‘deactivated’. The term ‘activated’ herein permits the system to make a modification to the initial date and the term ‘deactivated’ does not permit any modification.

According to the present disclosure, if the holiday data maintained on the system is changed, the above impacted dates need to be rescheduled based on the introduced changes. Changes in the holiday data set can include addition of a new holiday or making a marked holiday as working day. The processor 208 recalculates the impacted dates and stores it in a rescheduling module 210. If a first scheduled date is not impacted with the change in the holiday data set, the second rescheduled date remains the same as the first scheduled date. The rescheduled dates can be updated in the ‘bonds master’. According to one embodiment of the disclosure, the rescheduled dates can be shown to the user in an output interface 212. Alternatively, the rescheduled dates can be sent to a reporting module which can generate a report of the impacted dates to the user. [symbol] orts can include a success or a failure report and include the bond codes, impacted date types, previously maintained dates and new dates. In one embodiment of the disclosure, a calendar can be displayed in the GUI to show the impacted dates.

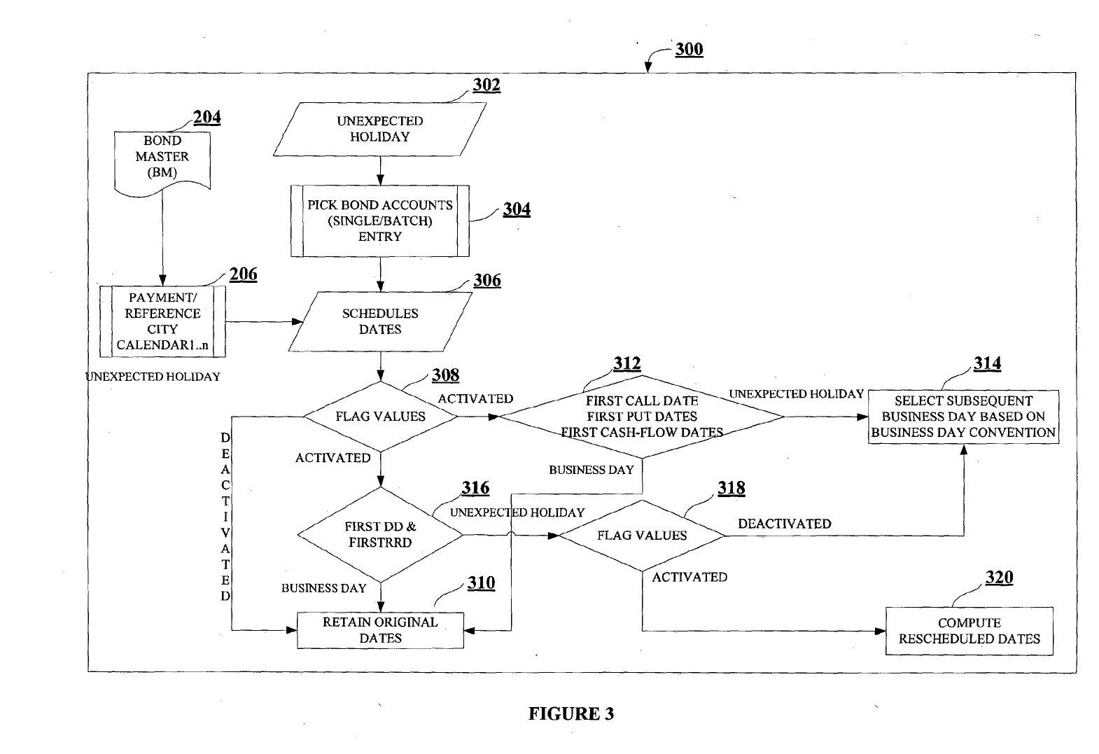

FIG. 3. is a flowchart 300 showing the functioning of the rescheduling module 208. The flow is triggered once an unexpected holiday is included or modified in the holiday data set 302. The user can be given an option to select the bonds, single or a group of bonds, for which the impacted dates are to be rescheduled. Accordingly single or batch bond accounts can be selected by the system 304. The scheduled dates 306 can be retrieved from the ‘bonds master’ 204. These include the ‘first determination date’ 204b, the ‘first reference rate date’ 204c, the ‘first call date’ 204d, the ‘first put date’ 204e and the ‘first cash-flow dates’ 204f. The dates are checked against the one or more selected payment city calendars and reference city calendars 206, in the ‘bonds master’ 204. The ‘bonds master’ can check the flag values 308 from the ‘flag values’ module 204g. If the flag value is set as deactivated then the system retains the original dates 310 and no changes are made to the impacted dates. Alternatively, if the flag value is set as activated, the system can proceed to check the impacted dates. If the ‘first call date’ and/or the ‘first put date’ and/or the ‘first cash-flow dates’ coincides with the unexpected holiday 310 entered in the holiday data set, then the business day subsequent to the first scheduled date to be rescheduled is selected as the second rescheduled date 314. The calculation of the second rescheduled dates can be based on the business day convention selected in the ‘bonds master’. The subsequent business days will be selected based on the respective payment city calendars. The system also checks for the ‘first determination date’ (hereinafter also referred to as the ‘first DD’) and for the ‘first reference rate date’ (hereinafter also referred to as the ‘first RRD’) 316. If [symbol] ys fall on a business day then no changes are made and the original dates are retained as the second rescheduled dates 310. If these dates fall on an unexpected holiday included in the holiday data set 8 for the first determination date and the first reference rate date is checked to determine whether the ‘bonds master’ has the value set as activated or deactivated. If the flag value is set as activated then the system recalculates the first DD and the first RRD to a second rescheduled date 320. If the flag value is set as deactivated then a business day subsequent to the first scheduled date to be rescheduled is selected as the second rescheduled date 310.

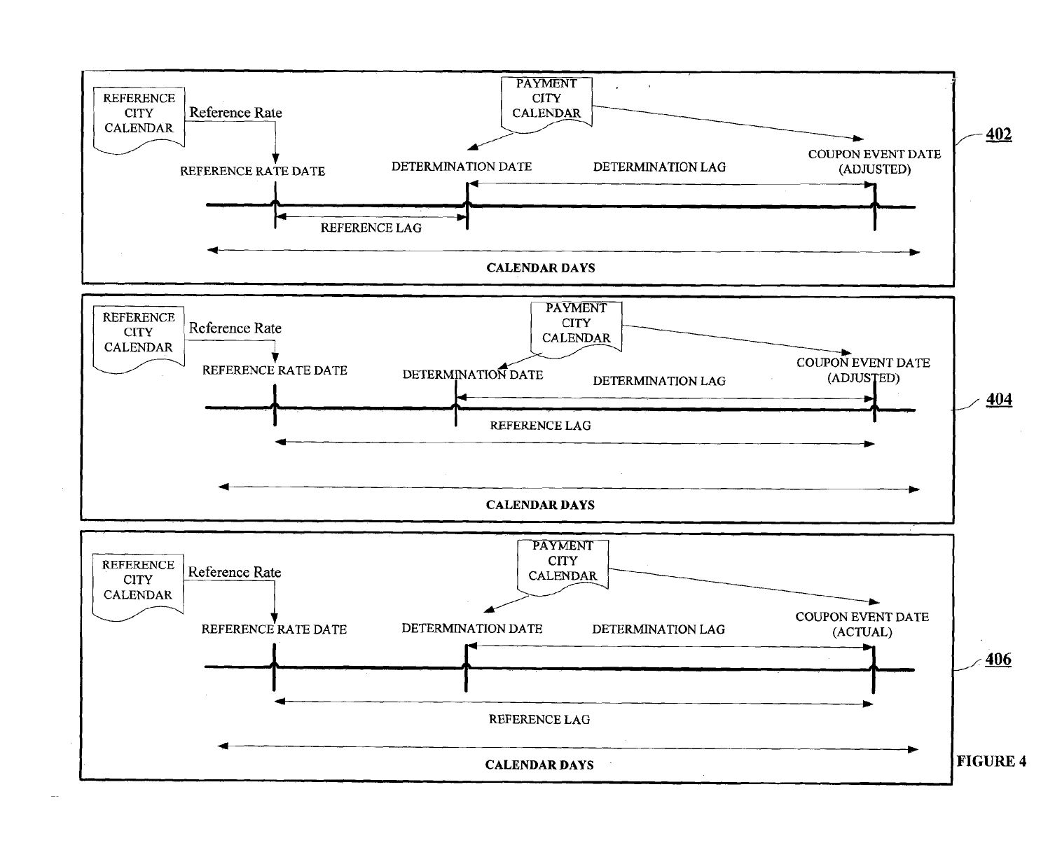

FIG. 4. shows how determination date and reference rate date is calculated. Determination date is the date when the system will attempt to determine the rate of the underlying coupon base. Determination lag is the number of days before the adjusted coupon event date to determine the determination date. This is the date the coupon rate will be determined. If this field is left blank the determination lag is automatically set to zero. Determination lag is used to determine the determination date for bonds based on whether the bonds are fixed in arrears or in advance. For bonds' fixed in arrears, determination date is calculated based on the following formula:

Determination Date=(Actual Coupon Event Date/Adjusted Coupon Event Date)−Determination Lag

For bonds' fixed in advance, determination date is calculated based on the following formula:

Determination Date=(Actual Coupon Event Date/Adjusted Coupon Event Date of Previous Coupon)−Determination Lag

Typically, determination date would be calculated using the adjusted event date, if the interest payout is adjusted 402, 404. Calculation based on actual coupon event date would happen if the interest payout is unadjusted 406. Reference rate date determines the date when the rate for the underlying coupon base must be considered for coupon rate determination. Reference city calendars are used to identify business days while calculating reference rate date. Reference rate date to be used to perform reference date calculation for various cash flows will be done based on parameterization done at ‘bonds master’. Reference lag is the number of days before the determination date the reference rate value needs to be picked. In case the reference rate is not maintained for that day then the latest available reference rate can be taken. If this field is left blank the reference lag is set to zero. Typically, for adjusted coupon bonds (adjusted interest payouts), the reference rate lag is quoted from the adjusted event date 402, 404. For unadjusted coupon bonds, reference date lag is quoted from actual coupon event date 406.

Illustrative example to calculate determination date and reference rate dates:
Bond Code in ‘bonds master’—B1
Value Date—Jan. 10, 2010
Holidays on Payment City Calendar—Jan. 9, 2011, Jan. 10, 2011 and Jan. 11, 2011
Holidays on Reference City Calendar—Jan. 8, 2011, Jan. 9, 2011, Jan. 11, 2011
Payout Schedule on System:

| Actual Coupon Event Date | Adjusted Coupon Event Date |
|---|---|
| 10^{th} Jan. 2011 | 12^{th} Jan. 2011 |
| 10^{th} Jan. 2012 | 10^{th} Jan. 2012 |

### Determination Date & Ref Date Calculation

### Case I:

Interest Payout—Adjusted
Interest Fixed in—Arrears
Determination Lag—1
Ref Rate Lag—2

### Determination Date (DD)

| Event Date | Adjusted Event Date | First Determination Date |
|---|---|---|
| 10^{th} Jan. 2011 | 12^{th} Jan. 2011 | 8^{th} Jan. 2011 |
| 10^{th} Jan. 2012 | 10^{th} Jan. 2012 | 9^{th} Jan. 2012 |

### Reference Rate Date (RRD)

| | | RRD based | RRD based | |
|---|---|---|---|---|
| | Adjusted | on actual | on adjusted | RRD Based |
| Event Date | Event Date | event date | event date | on DD |
| 10^{th} Jan. 2011 | 12^{th} Jan. 2011 | 6^{th} Jan. 2011 | 7^{th} Jan. 2011 | 6^{th} Jan. 2011 |
| 10^{th} Jan. 2012 | 10^{th} Jan. 2012 | 8^{th} Jan. 2012 | 8^{th} Jan. 2012 | 7^{th} Jan. 2012 |

### Case II:

Interest Payout—Unadjusted
Interest fixed in advance
Determination Lag—0
Ref. Rate Lag—2

### Determination Date (DD)

| Event Date | Adjusted Event Date | Determination Date |
|---|---|---|
| 10^{th} Jan. 2011 | 12^{th} Jan. 2011 | 10^{th} Jan. 2010 |
| 10^{th} Jan. 2012 | 10^{th} Jan. 2012 | 10^{th} Jan. 2011 |

### Reference Rate Date (RRD)

| | | RRD based | RRD based | RRD based on |
|---|---|---|---|---|
| | Adjusted | on actual | on adjusted | determination |
| Event Date | Event Date | event date | event date | date |
| 10^{th} Jan. 2011 | 12^{th} Jan. 2011 | 8^{th} Jan. 2010 | 8^{th} Jan. 2010 | 8^{th} Jan. 2010 |
| 10^{th} Jan. 2012 | 10^{th} Jan. 2012 | 6^{th} Jan. 2011 | 7^{th} Jan. 2011 | 8^{th} Jan. 2011 |

### Case III:

Interest Payout—Adjusted
Interest fixed in advance
Determination Lag—0
Ref Rate Lag—2

### Determination Date (DD)

| Event Date | Adjusted Event Date | Determination Date |
|---|---|---|
| 10^{th} Jan. 2011 | 12^{th} Jan. 2011 | 10^{th} Jan. 2010 |
| 10^{th} Jan. 2012 | 10^{th} Jan. 2012 | 12^{th} Jan. 2011 |

### Reference Rate Date (RRD)

| | | RRD based | RRD based | RRD based on |
|---|---|---|---|---|
| | Adjusted | on actual | on adjusted | determination |
| Event Date | Event Date | event date | event date | date |
| 10^{th} Jan. 2011 | 12^{th} Jan. 2011 | 8^{th} Jan. 2010 | 8^{th} Jan. 2010 | 8^{th} Jan. 2010 |
| 10^{th} Jan. 2012 | 10^{th} Jan. 2012 | 6^{th} Jan. 2011 | 7^{th} Jan. 2011 | 7^{th} Jan. 2011 |

These embodiments may be implemented with software, for example modules executed on computing devices such as computing device 100 of FIG. 1. Of course, modules described herein illustrate various functionalities and do not limit the structure of any embodiments. Rather the functionality of various modules may be divided differently and performed by more or fewer modules according to various design considerations.

Having described and illustrated the principles of the disclosure with reference to described embodiments and accompanying drawings, it will be recognized by a person skilled in the art that the described embodiments may be modified in arrangement without departing from the principles described herein.

What is claimed is:

1. A computer-implemented method executed by one or more computing devices for managing one or more bond accounts on the occurrence of at least one unexpected holiday, the method comprising:
receiving, by at least one of the computing devices, a data feed from a user, the data feed comprising data indicative of the at least one unexpected holiday;
fetching a first flag value for each of the one or more bond accounts, wherein the first flag value is set as activated or deactivated;
rescheduling existing dates for each of the one or more bond accounts in the event the flag value is set as activated, wherein the rescheduling of the existing dates comprises:
first determining, by at least one of the computing devices, whether a first determination date is concurrent with the at least one unexpected holiday;
fetching a second flag value for the first determination date of each of the one or more bond accounts, wherein the second flag value is set as activated or deactivated;
re-computing, by at least one of the computing devices, the first determination date to a second determination date in the event the first determination date is concurrent with the at least one unexpected holiday and the second flag value is activated;
next determining, by at least one of the computing devices, whether a first reference rate date is concurrent with the at least one unexpected holiday;
fetching a third flag value for the first reference rate date of each of the one or more bond accounts, wherein the third flag value is set as activated or deactivated;
re-computing, by at least one of the computing devices, the second reference rate date in the event the first reference rate date is concurrent with the at least one unexpected holiday and the third flag value is set as activated; and
selecting, by at least one of the computing devices, a business day subsequent to each of a remaining dates, in the event at least one of the remaining dates is concurrent with the at least one unexpected holiday, wherein the remaining dates include a first cash-flow date, a first call date and a first put date
selecting a business day subsequent to the first determination date as the second determination date in the event the second flag value is deactivated and the first determination date is concurrent with the at least one unexpected holiday;
selecting a business day subsequent to the first reference rate date as the second reference rate date in the event the third flag value is deactivated and the first reference rate date is concurrent with the at least one unexpected holiday; and
displaying, by at least one of the computing devices, the rescheduled dates to the user.

2. The method of claim 1, wherein the first flag value, the second flag value and the third flag value is fetched from an associated bond master for the one or more bond accounts.

3. The method of claim 1, wherein the first cash-flow date comprises a principal repayment date, an amortization date and a coupon event date.

4. The method of claim 1, wherein the one or scheduled dates are maintained in a payment city calendar specified in an associated bonds master for the one or more bond accounts.

5. The method of claim 1, wherein the reference rate date is maintained in a reference city calendar specified in an associated bond master for the one or more bond accounts.

6. The method of claim 1, wherein the second determinations date is re-computed using a determination lag.

7. The method of claim 1, wherein the second reference rate date is re-computed using a reference lag.

8. The method of claim 4, wherein the payment city calendar is synchronized with the rescheduled dates.

9. The method of claim 5, wherein the reference city calendar is synchronized with the rescheduled dates.

10. An automated system for managing at least one unexpected holiday for one or more bond accounts, the system comprising:
an input terminal for receiving a data feed from a user, the data feed comprising data indicative of the at least one unexpected holiday;
a computing system communicating with the input terminal comprising:
an associated bond master module comprising flag values for one or more scheduled dates, wherein the flag value is activated or deactivated;
a calendar module comprising a payment city calendar and a reference city for the associated bond master module;
a rescheduling module for rescheduling the one or more scheduled dates in the event the one or more rescheduled dates is concurrent with the at least one unexpected holiday; and
a reporting module for displaying the rescheduled dates to the user;
wherein the rescheduling module calculates a second determination date and a second reference rate date in the event the flag value is activated;
wherein the computing module selects a business day subsequent to each of the first determination date and the first reference rate date as the second determination date and the second reference date, in the event the flag value is deactivated.

11. The automated system of claim 10, wherein a business day subsequent to one or more remaining dates is selected in the event at least one of the remaining dates is concurrent with the at least one unexpected holiday.

12. The automated system of claim 12, wherein the remaining dates comprises a first call date, a first put date and a first cash-flow date.

13. The automated system of claim 13, wherein the first cash-flow date comprises a principal repayment date, an amortization date and a coupon event date.

14. The automated system of claim 11, wherein the second determinations date is re-computed using a determination lag.

15. The automated system of claim 11, wherein the second reference rate date is re-computed using a determination lag.

16. A computer readable medium having a set of instructions for execution on a computing device, the set of instructions comprising:
a bond master module routine for maintaining one or more bond accounts comprising a flag for the one or more scheduled dates, wherein the flag value is activated or deactivated;
a rescheduling routine for rescheduling a first determination date, a first reference rate date and a first call-put date to a second determination date, a second reference rate date and a second call-put date; wherein the one or scheduled dates are maintained in a payment city calendar in the bond master module of the one or more bond accounts, wherein the one or more scheduled dates are rescheduled in the event a first cash-flow date is concurrent with the at least one unexpected holiday; and
a reporting routine to display reports pertaining to the rescheduled dates.
